(19) United States
(12) Patent Application Publication
(10) Pub. No.: US 2006/0209549 A1
(43) Pub. Date: Sep. 21, 2006

(54) Trailer hitch cover system

(76) Inventor: David Valdez, West Jordan, UT (US)

Correspondence Address: MARCUS G THEODORE, PC, 466 SOUTH 500 EAST, SALT LAKE CITY, UT, 84102, US

(21) Appl. No.: 11/084,398

(22) Filed: Mar. 21, 2005

(51) Int. Cl. B60Q 1/00

(52) U.S. Cl. 362/485

(57) ABSTRACT

A rugged lighted decorative trailer hitch cover adapted for use with interchangeable patterned lens covers.

### BACKGROUND OF THE INVENTION

1. Field of Invention

The present invention relates to trailer hitch covers. In particular, it relates to a rugged lighted decorative trailer hitch cover adapted for use with interchangeable colored and patterned lens covers.

2. Description of Related Art

Various hitch covers are known. Bully Chrome Plated Customized Hitch Covers provide an unlighted chrome-plated die-cast metal cap with high-impact thermoplastic mounting stem adapted to fit all 2-inch receivers. The mounting stem slips within a trailer hitch receiver tube and secures therein with its hitch pin such that the cap keeps dirt out of the tube. Korky's.com discloses a skull hitch light cover light with skull design, which turns on with both the tail lamps and the brake lights. It employs multiple LED bulbs with diffuser for even lighting. It is made of plastic and has a pop out plain lens, which may be replaced with a design lens. NorthernTool.com discloses a similar skull hitch cover/brake light fitting vehicles with 1¼ inch or 2 inch hitch receivers.

Custom Logo Lite Manufacturing, Inc. discloses another plastic lighted, trailer hitch cover with a logo cover of the client's choice. It comes with an electrical connector that plugs into the four-way flat light connector on a vehicle such that when the vehicle lights are turned on, the hitch cover is also lit to be visible at night. Etrailer.com discloses a plastic lighted Chevrolet logo Brake Light Trailer Hitch Receiver for 2-inch trailer hitches. Korky's.com discloses a similar Jeep logo Brake Light Trailer Hitch Receiver. These are difficult to see at night, and are not shock resistant to accidental contact causing the plastic and design lenses to brake on contact.

The present invention described below provides a rugged lighted decorative trailer hitch cover adapted for use with interchangeable patterned lens cover inserts.

### SUMMARY OF THE INVENTION

The present invention comprises a lighted trailer hitch cover system for trailer hitch receivers of vehicles. It has a light source, which is preferably selectively activated by a vehicle's electrical lighting circuit. It comprises a hitch insert with one end adapted to secure within a trailer hitch receiver. Attached to other end of the hitch insert is a housing with an opening leading into an interior with light reflective surfaces sized to accommodate an electrical light-emitting source, such as a halogen bulb or a plurality of LED. If not associated with the vehicle's electrical lighting circuit, a battery power pack may be placed within the housing to activate the light-emitting source. When operating via the vehicle's electric lighting circuit, a plug in light attached to an electrical cord is placed within the interior via inserting its cord through a light socket in the housing and securing it thereto, such as with a screw in socket. The electrical cord is of sufficient length so its plug end can attach to the vehicle electrical lighting circuit for selective activation thereby. The light-emitting source is thus usually powered by the vehicle's battery and generator system, or an independent battery mounted within the housing. A control circuit is associated with the brakes, the accelerator and/or vehicle lights to selectively activate the light-emitting source to illuminate the decorative lens cover.

At least one transparent or translucent decorative lens cover covering the opening of the housing is included. A protective grid cover sized to secure over the decorative lens and removably fasten it to the housing then seals it thereto to provide a waterproof seal and prevent damage to the decorative lens from accidental contact. This protective grid cover may be removable to enable the device to be opened to change light bulbs or the decorative lens covers.

The housing, receiver and protective grid cover are constructed of metal or other contact resistant materials to prevent the decorative lens cover from damage by accidental contact or road vibration. The protective grid cover securing the decorative lens cover to the housing may include gaskets to aid in sealing the unit from the weather. This protective grid cover has light transmitting openings and may include a filigree design extending over the decorative lens cover to add additional protection to its center surfaces.

A plurality of interchangeable decorative lenses is generally used one at a time, but may be stacked to provide a layered patterned decorative lens effect. Thus different colors and designs may be mixed and matched to suit the preference of a user.

The wavelength frequency for light-emitting source generally produces a white light such as by employing a bright halogen bulb. However, other frequencies may be selected to provide different colors to enhance the design of the decorative lens or lenses. Generally, the light-emitting source comprises a single halogen bulb, but may be altered to include a plurality of halogen or LED lights.

The shape of the decorative lens cover housing and protective grid may be configured as a sculpted distinctive design of a common theme with the decorative lens. Consequently, they may be shaped to provide the outline of the logo or pattern corresponding to that depicted by the decorative lens cover.

The present invention is therefore particularly adapted provide a rugged lighted decorative trailer hitch cover adapted for use with interchangeable patterned lens covers.

### BRIEF DESRIPTION OF THE DRAWINGS

FIG. 1 is an exploded view of a preferred embodiment of the invention.

FIG. 2 is an assembled view of the embodiment of the invention shown in FIG. 1.

FIG. 3 is a front view of a preferred embodiment of a decorative lens of the invention.

FIG. 4 is a front view of a preferred embodiment of a clear colored lens of the invention.

FIG. 5 is a front view of a preferred embodiment a filigreed protective grid cover for use with the colored lens of FIG. 4.

FIG. 6 is a side cross sectional view of another preferred embodiment of the invention.

FIG. 7 is a side cross sectional view of another preferred embodiment of the invention.

### DESCRIPTION OF THE ILLUSTRATED EMBODIMENTS

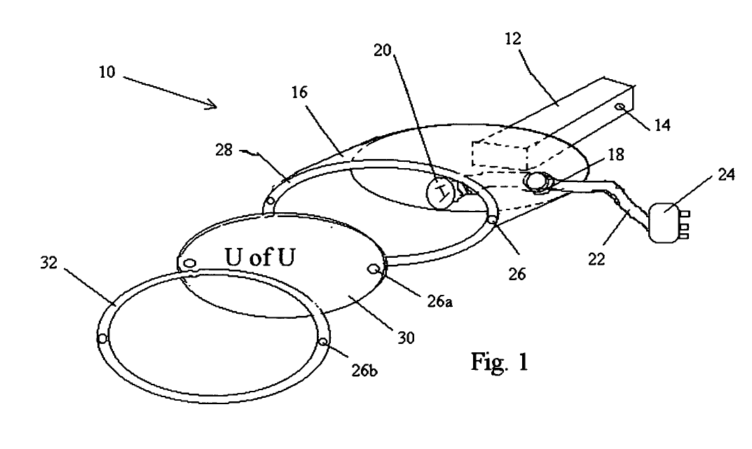

FIG. 1 is an exploded view of a preferred embodiment of the invention 10. It comprises a lighted trailer hitch cover system 10 for trailer hitch receivers of vehicles and trucks, and is selectively activated by the electrical lighting circuit of the vehicle. It comprises a hitch insert 12 a hitch insert with one end adapted to secure within a trailer hitch receiver. This end has a locking hole 14 to secure the hitch insert 12 within the receiver via a locking pin or lock (not shown) when placed there through to secure the hitch insert 12 to the hitch receiver. The hitch insert 12 is structured to slide within either a standard 1¼ or 2 inch trailer hitch receiver and is preferably made of metal.

Attached to other end of the hitch insert 12 is a universal ⅛ inch steel housing 16 with a threaded opening 18 leading into its interior epoxy covered light reflective surfaces is attached to the exposed end of the hitch insert 12. The housing interior is sized to accommodate an electrical light-emitting source 20.

The light-emitting source 20 comprises a halogen bulb attached to one end of a power cord 20 placed within the interior such that its cord passes through the housing 16. It is secured within the interior housing 16 via a wire nut (not shown) inserted in the opening 18 such that the power chord 20 passing there through is securely held therein and is of sufficient length to attach its wire plug 24 end to the vehicle electrical lighting circuit for selective activation thereby.

Screw holes 26 are placed along the rim 28 of the housing 16 surrounding its open interior. A least one transparent or translucent decorative lens cover 30 sized to cover the rim 28 defining the opening of the housing 16. The decorative lens cover 30 has perimeter holes 26a aligned with the screw holes 26 of the rim 28.

A protective grid cover 32 is sized and adapted to secure over the decorative lens 30 to fasten it to the housing 16 rim 28 to prevent damage to the decorative lens 30 if accidentally contacted when the vehicle backs into something.

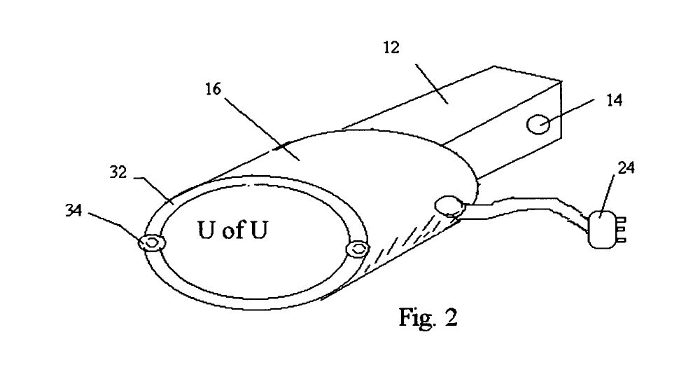

FIG. 2 is an assembled view of the embodiment of the invention shown in FIG. 1 held together with threaded bolts 34 aligned to fit through holes 26a and 26b and screw into the screw holes 26. Thus secured, the protective grid cover 32 secures the decorative lens cover 30 to the housing 16 to form a waterproof seal.

The housing 16 and protective grid cover 32 are constructed of ⅛ inch plate steel chromed to frame and accentuate the design of the decorative lens cover 30.

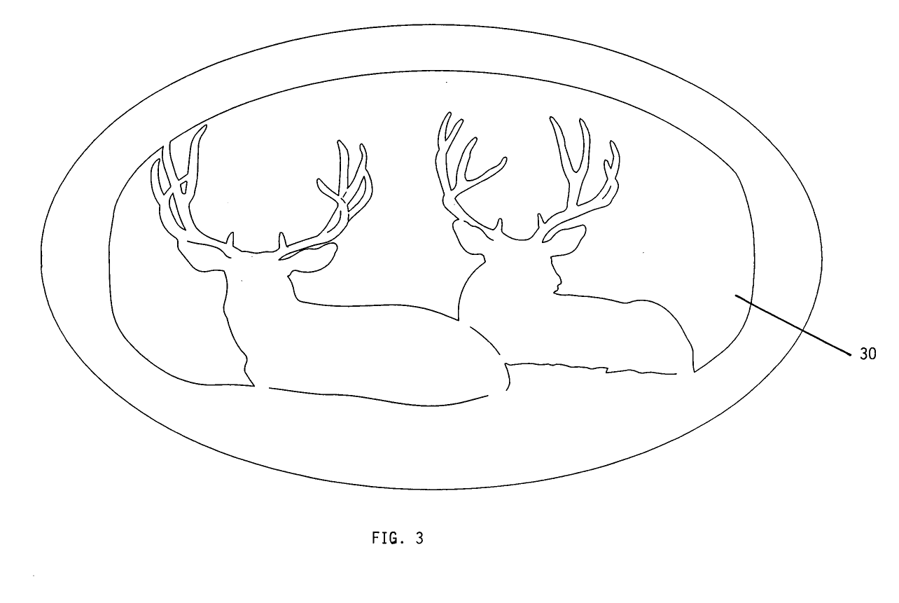

FIG. 3 is a front view of a preferred embodiment of a decorative lens cover 32 of the invention. This decorative lens cover 32 is translucent and can be stacked with the lens cover shown in FIG. 2 to provide a combination-layered pattern.

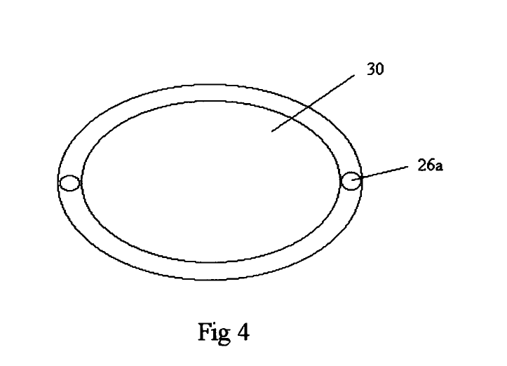

FIG. 4 is a front view of a preferred embodiment of a clear colored lens cover 32 of the invention, which may be used alone or combined with other decorative lens covers 32, such as those shown in FIGS. 2 and 3.

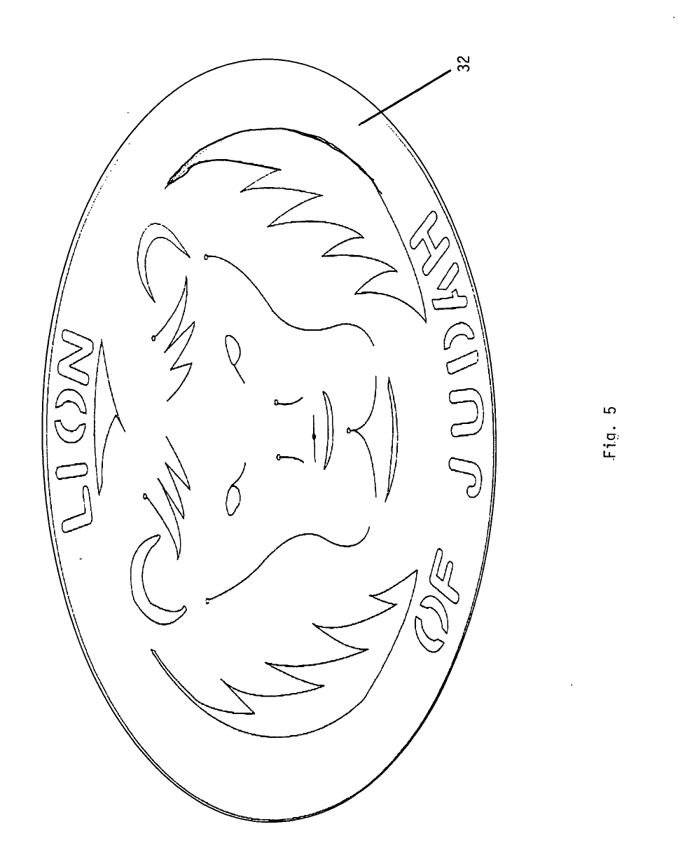

FIG. 5 is a front view of a preferred embodiment a filigreed protective grid cover 32 for use with the colored lens 32 of FIG. 4. The holes in the filigree pattern allow light to pass there through to transmit colored light in a pattern to suit the preference of a user.

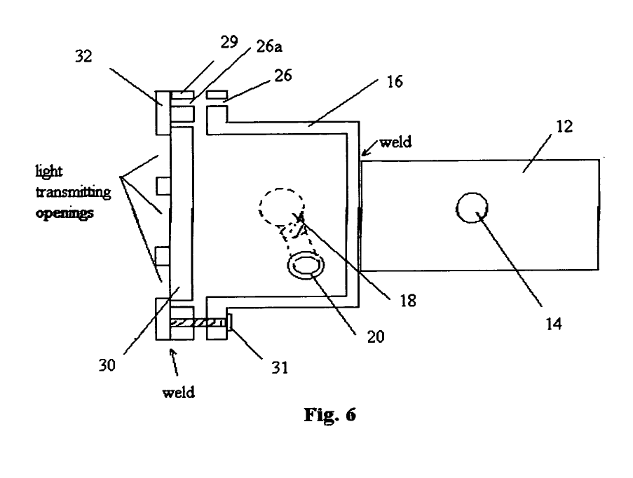

FIG. 6 is a side cross sectional view of another preferred two-piece grid cover embodiment of the invention 10. It comprises a hitch insert 12 a hitch insert with one end adapted to secure within a trailer hitch receiver. This end has a locking hole 14 to secure the hitch insert 12 within the receiver via a ⅝ inch or ½ inch locking pin when placed there through to secure the hitch insert 12 to the hitch receiver. The hitch insert 12 is made of 1¼ inch or 2 inch square metal tubing to slide within either a standard 1¼ or 2 inch trailer hitch.

Attached to other end of the hitch insert 12 via welds is a universal ⅛ inch steel housing 16 with a threaded light socket 13/16 inch opening 18 leading into its interior. The interior is also epoxy covered to provide light reflective surfaces for an H11157 halogen bulb light-emitting source 20 inserted within the opening 18. The housing interior is square shaped and sized to accommodate the halogen bulb 20.

The H1157 halogen bulb 20 is attached to one end of a power cord 20 and inserted within and fastened to the housing 16 with a wire nut attached to the cord (not shown). The power chord 20 has a wire plug end 24 and is of sufficient length to attach its wire plug end 24 to the vehicle's electrical lighting circuit for selective activation thereby.

Screw holes 26 are placed along the rim 28 of the housing 16 surrounding its open interior. A center plate 29 with corresponding screw holes 26a is placed over the open interior leaving an exposed lip of the rim 28. At least one transparent or translucent decorative lens cover 30 sized to cover the rim 28 opening rests on its lip. The decorative lens cover 30 has perimeter holes 26a aligned with the screw holes 26 of the rim 28.

A protective grid cover 32 faceplate with light transmitting openings is sized and welded to the center late 29. The grid cover 32 face plate is then secured over the decorative lens 30 by bolt back plate screws 31 inserted into screw holes 26 and 26a to securing the center plate 29 and its welded grid cover 32 face plate to the rim 28 to prevent damage to the decorative lens 30 if accidentally contacted when the vehicle contacts an object. Thus secured, it also provides a weather tight case.

This embodiment allows decorative lenses 30 to be interchanged by simply separating the components via removable fasteners, such as screws, bolts, and clips. It also allows the halogen bulb 20 to be replaced without having to remove the grid cover 32.

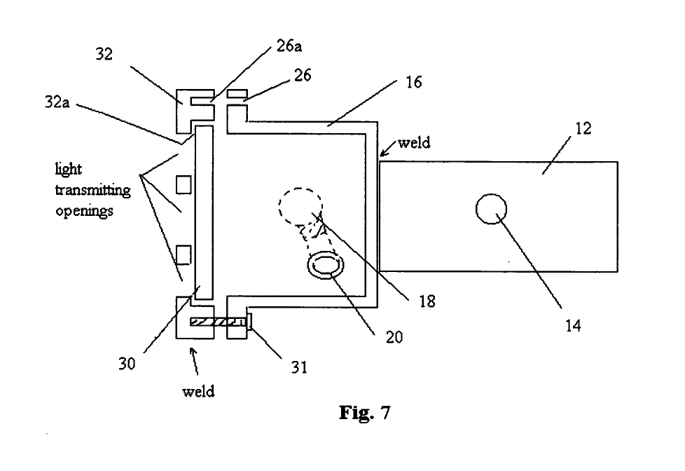

FIG. 7 is a side cross sectional view of another preferred one-piece grid cover embodiment of the invention 10. Instead of a center plate 29, it has a face plate 32 with an off-set back 32a sized to fit around the decorative lenses 30 and removably secure them to the rim 28 via a similar screw hole system 26. This faceplate 32 with the off-set back 32a may be molded of a single piece or machined to leave the appropriate off-sets.

The above description and specification should not be construed as limiting the scope of the claims. The scope of the claims is therefore to be determined by the parameters contained in the appended claims and their legal equivalents.

I claim:

1. A lighted trailer hitch cover system for trailer hitch receivers of vehicles with selectively activated electrical lighting circuits comprising:
a. a hitch insert having first and second ends, with the first end structured and adapted to removably secure within a trailer hitch receiver,
b. an open top housing with sides and a bottom defining an open interior sized to accommodate an electrical light-emitting source and provide light reflective interior surfaces, said bottom attached to the second end of the hitch insert,
c. a light-emitting source mounted within the housing interior for selective activation,
d. at least one transparent or translucent decorative lens cover covering the open top of the housing, and
e. a protective grid cover with light transmitting openings adapted to removably secure over the decorative lens to seal it to cover the open top housing, the protective grid structured to resist accidental contact and prevent damage to the decorative lens.

2. A lighted trailer hitch cover system according to claim 1, wherein the sides have a portal therein and the interior light-emitting source comprises a light attached to a first end of a power cord passing through and secured to the portal and having a second plug end, the power cord of a length to attach its plug end to the vehicle's electrical lighting circuit for selective activation thereby.

3. A lighted trailer hitch cover system according to claim 1, wherein the housing, receiver and protective grid cover are constructed of metal or a metal-like material of similar strength and hardness.

4. A lighted trailer hitch cover system according to claim 1, wherein the protective grid cover securing the decorative lens cover to cover the open top housing forms a weatherproof seal.

5. A lighted trailer hitch cover system according to claim 1, including a plurality of interchangeable light transmitting decorative lenses, which may be stacked and sealed over the open top housing to provide a desired layered pattern.

6. A lighted trailer hitch cover system according to claim 1, wherein the wavelength frequency for light-emitting source is selected to enhance the design of the decorative lens or lenses.

7. A lighted trailer hitch cover system according to claim 1, wherein the light-emitting source comprises a plurality of halogen lights.

8. A lighted trailer hitch cover system according to claim 1, wherein the decorative lens cover, housing, and protective grid have a distinctive shaped design outlining the logo contained on the decorative lens cover.

9. A lighted trailer hitch cover system according to claim 1, wherein the power source is a battery mounted within the housing.

10. A lighted trailer hitch cover system according to claim 1, wherein the lens cover is replaceable and can be interchanged with other lens covers having colors and decorative patterns to suit the preference of a user.

11. A lighted trailer hitch cover system for trailer hitch receivers of vehicles with selectively activated electrical lighting circuits comprising:
a. a hitch insert having first and second ends, with the first end structured and adapted to removably secure within a trailer hitch receiver,
b. a housing with a rim defining an open top, sides with a light socket portal, and a bottom defining an open interior sized to accommodate an electrical light-emitting source and provide light reflective interior surfaces, said bottom attached to the second end of the hitch insert,
c. a power cord with a plug attached at one end and a light bulb attached to the other end mounted within the housing interior by removably securing it to the light socket portal, the power cord of a length to attach its plug end to the vehicle's electrical lighting circuit for selective activation thereby,
d. at least one transparent or translucent decorative lens cover sized to cover the open top of the housing, and
e. a protective grid cover with light transmitting openings with an off-set back opening sized to accommodate the decorative lenses when secured over the lenses, and a front face structured to secure to and cover the housing rim such that when the grid is removably fastened to the rim of the housing with fasteners the decorative lens seals the housing open top

12. A lighted trailer hitch cover system according to claim 11, wherein the housing, and protective grid have a sculpted design complimentary to that of the decorative lens cover.

13. A lighted trailer hitch cover system for trailer hitch receivers of vehicles with selectively activated electrical lighting circuits comprising:
a. a hitch insert having first and second ends, with the first end structured and adapted to removably secure within a trailer hitch receiver,
b. a housing with a rim defining an open top, sides with a light socket portal, and a bottom defining an open interior sized to accommodate an electrical light-emitting source and provide light reflective interior surfaces, said bottom attached to the second end of the hitch insert,
c. a power cord with a plug attached at one end and a light bulb attached to the other end mounted within the housing interior by removably securing it to the light socket portal, the power cord of a length to attach its plug end to the vehicle's electrical lighting circuit for selective activation thereby,
d. a center plate with an opening sized larger than the housing open top to attach to the rim of the open top housing leaving a portion of the rim exposed to form a circumferential lip,
e. at least one transparent or translucent decorative lens cover sized to rest on the circumferential lip to cover the open top of the housing, and
f. a protective grid cover with light transmitting openings structured to resist accidental contact secured to and covering the center plate such that when the center plate is removably fastened to the rim of the housing with fasteners the decorative lens seals the housing open top.

14. A lighted trailer hitch cover system according to claim 13, wherein the housing, and protective grid have a sculpted design complimentary to that of the decorative lens cover.
